(19) United States
(12) Patent Application Publication
(10) Pub. No.: US 2016/0264808 A1
(43) Pub. Date: Sep. 15, 2016

(54) INK, INK-JETTING RECORDING METHOD, AND RECORD THEREOF

(71) Applicants: Masahiro KIDO, Ebina (JP); Naohiro Toda, Yokohama (JP); Juichi Furukawa, Yokohama (JP); Hidefumi Nagashima, Atsugi (JP); Tomohiro Nakagawa, Sagamihara (JP); Noriaki Okada, Yokohama (JP); Hikaru Kobayashi, Yokohama (JP)

(72) Inventors: Masahiro KIDO, Ebina (JP); Naohiro Toda, Yokohama (JP); Juichi Furukawa, Yokohama (JP); Hidefumi Nagashima, Atsugi (JP); Tomohiro Nakagawa, Sagamihara (JP); Noriaki Okada, Yokohama (JP); Hikaru Kobayashi, Yokohama (JP)

(21) Appl. No.: 15/062,300

(22) Filed: Mar. 7, 2016

(30) Foreign Application Priority Data
Mar. 9, 2015 (JP) 2015-045895
Feb. 24, 2016 (JP) 2016-033621

(51) Int. Cl. C09D 11/38; C09D 11/106; C09D 11/102

(52) U.S. Cl. CPC C09D 11/38; C09D 11/102; C09D 11/106

(57) ABSTRACT

Ink having high adhesiveness for various substrates. The ink contains water, an organic solvent, at least one compound selected from formulae (1) and (2), and at least two kinds of resin particles. Ink-jet method. Record.

### RELATED APPLICATIONS

This application claims priority to Japanese patent application JP2015-045895, filed Mar. 9, 2015, and to Japanese patent application JP2016-033621, filed Feb. 24, 2016, both incorporated herein by reference.

### TECHNICAL FIELD

An ink, ink-jetting recording method, and record thereof are described.

### BACKGROUND

In industry use, a substrate such as a plastic film is used to improve lightfastness, water resistance, and rub fastness, and ink used for such substrates have been developed.

Solvent ink-jetting inks using a vehicle as a solvent, and ultraviolet curable inks including polymerizable monomers as a main component, have been widely used as the inks mentioned above. However, solvent ink-jetting inks have a problem in that their influence on the environment caused by evaporation of the solvent is potentially detrimental. As for ultraviolet curable inks, the options of which momomers can be used for the ink is limited in terms of safety.

Therefore, water based inks having a low stress on the environment and being able to directly record on a substrate having non-osmosis have been suggested; see patent literature 1 and 2:
Patent literature of 1: Japanese Laid-Open Patent Publication No. 2005-220352
Patent literature of 2: Japanese Laid-Open Patent Publication No. 2011-094082

### SUMMARY

An object of the present disclosure is to provide an ink having high adhesiveness for various substrates including a substrate having non-osmosis, the ink preferably having one or more of high rub fastness, solvent resistance, and non-transfer properties, and further preferably also having high image hardness and high glossiness.

The ink meeting these requirements is described herein and comprises water, an organic solvent, at least one compound selected from formulae (1) and (2) below, and at least two kinds of resin particles:

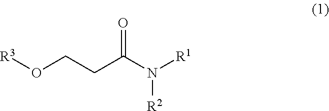

In formula (1) R¹, R², and R³, which may be the same or different, each independently represents an alkyl group having 1 to 5 carbon atoms.

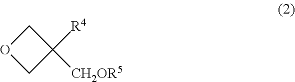

In formula (2) R⁴ represents a methyl group or an ethyl group, and R⁵ represents a hydrogen atom, an alkyl group having 1 to 8 carbon atoms, a cycloalkyl group or an aryl group.

### BRIEF DESCRIPTION OF THE DRAWINGS

FIG. 1 is a schematic diagram illustrating an example of a serial type ink jet recording device.

FIG. 2 is a schematic diagram illustrating the structure of the device illustrated in FIG. 1.

### DETAILED DESCRIPTION OF THE PREFERRED EMBODIMENTS

The ink comprises water, an organic solvent, at least one compound selected from formulae (1) and (2) below, at least two kinds of resin particles, and can optionally include other components:

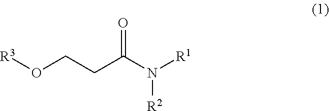

In formula (1) R¹, R², and R³, which may be the same or different, each independently represents an alkyl group having 1 to 5 carbon atoms.

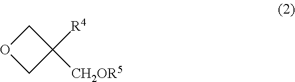

In formula (2) R⁴ represents a methyl group or an ethyl group, and R⁵ represents a hydrogen atom, an alkyl group having 1 to 8 carbon atoms, a cycloalkyl group or an aryl group.

Two different types of resin particles are components of the ink. These particles significantly affect image quality. Examples of the resin particles include, e.g., acrylic resin particles, polyurethane resin particles, polyester resin particles, etc. and each of resin particles has its own properties. There is a problem that it is difficult to make one kind of resin have two properties (e.g. acrylic resin particles show preferable image hardness but are lacking in solvent resistance). One resolution to solve this problem is to use at least two kinds of resin particle in combination, however, the desired effect is not obtained when the at least two kinds of resin particle cancel each other's beneficial property, for example when miscibility and compatibility of the resin particles is poor.

It is found that the miscibility of at least two kinds of resin particles can be enhanced in the process of drying an ink adhered to a recorded medium by adding an organic solvent that can dissolve the at least two kinds of resin particles. One resin particle is defined as a resin particle included in the ink in the largest amount. The other resin particle(s) are defined as resin particle(s) other than the resin particle included in the ink in the largest amount. A resin film in which the other resin particles are uniformly dispersed in a continuous phase (may be a continuous layer) can be obtained when the content ratio of the other resin particles with respect to the content of the resin particle included in the ink in the largest amount is in a specified range. The resin film has properties which are derived from both the resin particle included in the ink in the largest amount and the other resin particle(s). Further, it is considered that the other resin particles which are dispersed can give thermodynamic stability to the resin particle included in the ink in the largest amount.

The compound(s) represented by formulae (1) and (2) affect the at least two kinds of resin particles by assisting the formation of a state of preferable mixing during the ink drying process, and consequently, can bring out a synergistic effect of the properties of the at least two kinds of resin particles when an image is recorded with the ink described herein including the at least two kinds of resin particles.

### Compounds Represented by Formulae (1) and (2)

Compounds represented by formulae (1) and (2) are described above. The compound represented by formula (1) is preferable in terms of adhesiveness, rub fastness, non-transfer property, and high glossiness.

In formula (1), R¹, R², and R³ may be the same or different, and each independently represents an alkyl group having 1 to 5 carbon atoms. Specific examples of the alkyl group having 1 to 5 carbon atoms include a methyl group, an ethyl group, a propyl group, an isopropyl group, a butyl group, and a pentyl group. Specific examples of the compound represented by formula (1) include 3-methoxy-N,N-dimethylpropionamide (1-1), 3-butoxy-N,N-dimethylpropionamide (1-2), and 3-methoxy-N,N-diethylpropionamide.

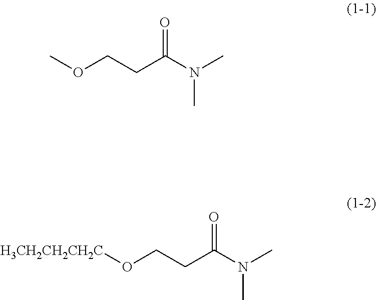

These compounds can be used independently or in combination. Among these compounds, 3-methoxy-N,N-dimethylpropionamide (1-1) is preferable in terms of adhesion property, rub fastness, non-transfer property, and high glossiness.

The compounds represented by the general formula (1) enhance compatibility between the organic solvent and the resin particles and improves dispersibility. Also, compounds represented by formula (1) have a high osmotic property with respect to a substrate having non-osmosis, so that sufficient wettability with respect to the ink substrate can be obtained. Preferable dispersion stability of the resin particles in ink, an improvement of homogeneity of the solid image, and an enhancement of film formation are obtained by using the compounds represented by formula (1) with the resin particles and the organic solvent, especially those having a certain extent of affinity and a relatively low boiling point such as 1,2-propanediol, 1,3-propanediol, 1,2-butanediol, 1,3-butanediol, and 2,3-butanediol. Further, high rub fastness and high solvent resistance can be obtained even just after drying as a result of the enhancement of film formation.

Further specific examples of compounds represented by formula (1) include, for example, Equamide M-100 (manufactured by Idemitsu Kosan Co. Ltd., 3-methoxy-N,N-dimethylpropionamide; in the general formula (1), R¹ is a methyl group, R² is a methyl group, R³ is a methyl group) and Equamide B-100 (manufactured by Idemitsu Kosan Co., Ltd., 3-butoxy-N,N-dimethylpropionamide; in the general formula (1) R¹ is a methyl group, R² is a methyl group, R³ is a butyl group). These compounds can be used independently or in combination.

In the general formula (2), R⁴ represents a methyl group or an ethyl group, and R⁵ represents one of a hydrogen atom, an alkyl group having 1 to 8 carbon atoms, a cycloalkyl group and an aryl group. A hydrogen atom is preferable as R⁵. Specific examples of the alkyl group having 1 to 8 carbon atoms includes a methyl group, an ethyl group, a propyl group, an isopropyl group, a butyl group, a pentyl group, a hexyl group, a heptyl group, and an octyl group. Specific examples of the compound represented by formula (2) include 3-methyl-3-oxetanemethanol (2-1) and 3-ethyl-3-oxetanemethanol (2-2). These compounds can be used independently or in combination.

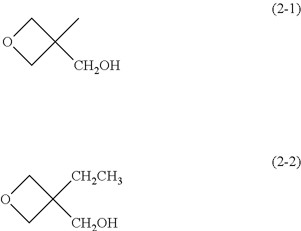

The preferable content of a compound represented by at least one of formulae (1) and (2) (i.e., the total amount of compounds of formulae (1) and (2) in the ink) is from 5 mass % to 55 mass % with respect to the total amount of ink. More preferable is from 10 mass % to 45 mass % with respect to the total amount of ink. Mixing uniformity can be improved when the content is from 5 mass % to 55 mass %, therefore preferable discharging property can be obtained when ink is applied via an ink jet recording method. Further, ink having high wettability with respect to a substrate having non-osmosis can be easily produced.

The phrase “at least one compound selected from formulae (1) and (2)” would be satisfied by all of the following nonexclusive examples: two compounds of formula (1); a compound of formula (2); a compound of formula (1) and a compound of formula (2); etc.

The content of a compound represented by at least one of formulae (1) and (2) in the ink can be identified with Gas Chromatography Mass Spectrometry (GCMS). Specifically, content of a compound represented by at least one of the general formulas (1) and (2) in ink can be identified by introducing ink without filtering to GCMS and conducting qualitative analysis of the compounds included in the ink. Each of the compounds included in the ink can be qualitatively and quantitatively analyzed by making a standard curve of concentration for each of the compounds.

### Resin Particles

In the present ink, at least two kinds of resin particles are used. Specific examples of the resin particles include, but are not limited to, a polyester resin particle, a polyurethane resin particle, an epoxy resin particle, a polyamide resin particle, a polyether resin particle, an acrylic resin particle, an acryl-silicone resin particle, a condensed synthetic resin particle such as a fluorine resin particle, a polyolefin resin particle, a polystyrene resin particle, a polyvinyl alcohol resin particle, a polyvinyl ester resin particle, a polyacrylic acid resin particle, an addition synthetic resin particle such as an unsaturated carboxylic acid resin particle, a cellulose derivative resin particle, a rosin derivative resin particle, and a natural high molecule resin particle such as a natural rubber resin particle. Among these rein particles, the acrylic resin particle, the acryl-silicone resin particle, and the polyurethane resin particle are preferable in terms of fixing properties and stability. The polyurethane resin is preferable in terms of rub fastness of images. A polyvinylchloride resin particle and a polyester resin particle is preferable in terms of adhesion property with respect to a substrate having non-osmosis and solvent resistance. The acrylic resin particle is preferable in terms of hardness of images.

The polyurethane resin particle made from a polyurethane resin is preferable as one of the at least two kinds of resin particles in terms of rub fastness of images and high glossiness. Using the the polyurethane resin particle in combination with the polyvinylchloride resin particle is preferable in terms of rub fastness of images, high glossiness, and adhesion property.

Rub fastness of images and high glossiness each derived from property of the polyurethane resin particle and solvent resistance and adhesion property with respect to a recording medium having non-osmosis each derived from property of the polyvinylchloride resin particle can be obtained by using the polyurethane resin particle in combination with the polyvinylchloride resin particle as the resin particles. Rub fastness derived from use of the polyurethane resin particle can be more remarkably improved than that expected simply as estimated from the sum of properties of both resin particles. For all resin particles synthetic compounds or compounds on the market can be used.

Polyurethane Resin Particle

Specific examples of the polyurethane resin include, but are not limited to, a polyurethane resin particle obtained by reacting polyols with polyisocyanates. Specific examples of the polyols include a polyether polyol, a polycarbonate polyol, and a polyester polyol. These polyols can be used independently or in combination.

Polyether Polyol

Specific examples of the polyether polyol include a polyether polyol obtained by the addition polymerization of an alkylene oxide using one or more than two kinds of compounds having two or more active hydrogen atoms as a starting material. Specific examples of the starting material include ethylene glycol, diethylene glycol, triethylene glycol, propylene glycol, trimethylene glycol, 1,3-butanediol, 1,4-butanediol, 1,6-hexanediol, glycerine, trimethylolethane, and trimethylolpropane. These starting materials can be used independently or in combination. Specific examples of the alkylene oxide include ethylene oxide, propylene oxide, butylene oxide, styrene oxide, epichlorohydrin, and tetrahydrofuran. These alkylene oxides can be used independently or in combination. Specific examples of the polyether polyol include polyoxytetramethylene glycol and polyoxypropylene glycol in terms of obtaining ink binder that can bring extremely high rob fastness to ink. These polyether polyol can be used independently or in combination.

Polycarbonate Polyol

Specific examples of the polycarbonate polyol that can be used for manufacturing a polyurethane resin particle include a polycarbonate polyol obtained by reacting carbonic esters and polyols and a polycarbonate polyol obtained by reacting phosgene and bisphenol A. These polycarbonate polyol can be used independently or in combination. Specific examples of the carbonic esters include methyl carbonate, dimethyl carbonate, ethyl carbonate, diethyl carbonate, cyclocarbonate, and diphenyl carbonate. These carbonic esters can be used independently or in combination. Specific examples of the polyol include dihydroxy compound having relatively low molecular weight such as ethylene glycol, diethylene glycol, triethylene glycol, 1,2-propylene glycol, 1,3-propylene glycol, dipropylene glycol, 1,4-butanediol, 1,3-butanediol, 1,2-butanediol, 2,3-butanediol, 1,5-pentandiol, 1,5-hexanediol, 2,5-hexanediol, 1,6-hexanediol, 1,7-heptanediol, 1,8-octanediol, 1,9-nonanediol, 1,10-decandiol, 1,1-undecanediol, 1,12-dodecanediol, 1,4-cyclohexanediol, 1,4-cyclohexanebismethanol, hydroquinone, resorcin, bisphenol A, bisphenol F, and 4,4′-biphenol, polyetherpolyol such as polyethylene glycol, polypropylen glycol, and polyoxytetramethylene glycol, polyester polyol such as polyhexamethylene adipate, polyhexamethylene succinate, and polycaprolactone. These polyol can be used independently or in combination.

Polyester Polyol

Specific examples of the polyester polyol include a polyester polyol obtained by esterifying low molecular weight polyol with polycarboxylic acid, a polyester polyol obtained by the ring opening polymerization of cyclic ester compounds such as ε-caprolactone, and copolymer of these polyester polyols. These polyester polyol can be used independently or in combination. Specific examples of the low molecular weight polyol include ethylene glycol and propylene glycol. These low molecular weight polyols can be used independently or in combination. Specific examples of the polycarboxylic acid include succinic acid, adipic acid, sebacic acid, dodecanedicarboxylic acid, terephthalic acid, isophthalic acid, phthalic acid, anhydrides of these, and ester-forming derivative. These polyester polycarboxylic acids can be used independently or in combination.

Polyisocyanate

Specific examples of the polyisocyanate include aromatic diisocyanate such as phenylene diisocyanate, tolylene diisocyanate, diphenyl methane diisocyanate, and naphthalene diisocyanate, and aliphatic or alicyclic diisocyanate such as hexamethylene diisocyanate, lysine diisocyanate, cyclohexane diisocyanate, isophorone diisocyanate, dicyclohexylmethane diisocyanate, xylylene diisocyanate, tetramethylxylylene diisocyanate, and trimethylhexamethylene diisocyanate. These polyisocyanate can be used independently or in combination. Aliphatic or alicyclic diisocyanate is preferable among these polyisocyanate in terms of long-term outdoor weatherability because ink of the present disclosure can be used for outdoor products such as outdoor poster and outdoor signboard. Film strength and rub fastness, which are aimed at being obtained in the present disclosure, can be easily obtained by using at least one of alicyclic diisocyanate. Specific examples of the alicyclic diisocyanate include isophorone diisocyanate and dicyclohexylmethane diisocyanate. Preferable content of the alicyclic diisocyanate is 60 mass % or more with respect to the total amount of the isocyanate compound.

Manufacturing Method of Polyurethane Resin Particle

Polyurethane resin particles used in the ink of the present disclosure can be obtained for example by a conventional method, for example, the following method is available. The first step is manufacturing isocyanate-terminated urethane prepolymer by reacting polyol with polyisocyanate at equivalence ratio that makes an excess of isocyanate group under non-solvent condition or in presence of organic solvent. The second step is neutlizing anionic group in the isocyanate-terminated urethane prepolymer by a neutralizing agent as necessary, and reacting with a chain extender. The third step is removing the organic solvent remaining in the reaction system as necessary. After that the polyurethane resin particle can be obtained.

Specific examples of the organic solvent used for the manufacturing polyurethane resin particle include ketones such as acetone and methyl ethyl ketone, ethers such as tetrahydrofuran and dioxane, acetic acid esters such as ethyl acetate and butyl acetate, nitriles such as acetonitrile, and amides such as dimethylformamide, N-methylpyrrolidone, and N-ethylpyrrolidone. These organic solvent can be used independently or in combination. Specific examples of the chain extender include polyamine and active hydrogen group containing compound other than polyamine. These chain extenders can be used independently or in combination.

Specific examples of the polyamine include amines such as ethylenediamine, 1,2-propanediamine, 1,6-hexamethylenediamine, piperazine, 2,5-dimethylpiperazine, isophorondiamin, and dicyclohexylmethanediamine, polyamines such as dipropylenetriamine, and triethylenetetramine, hydrazines such as hydrazine, N,N′-dimethylhydrazine, and 1,6-hexamethylene bishydrazine, and dihydrazides such as adipic acid dihydrazide, glutaric acid dihydrazide, sebacic acid dihydrazide, isophthalic acid dihydrazide. These polyamines can be used independently or in combination.

Specific examples of the active hydrogen group containing compound other than polyamine includes glycols such as ethylene glycol, diethylene glycol, triethylene glycol, propylene glycol, 1,3-propanediol, 1,3-butanediol, 1,4-butanediol, hexamethylene glycol, sucrose, methylene glycol, glycerin, and sorbitol, and phenols such as bisphenol A, 4,4′-dihydroxydiphenyl, 4,4′-dihydroxydiphenyl ether, 4,4′-dihydroxydiphenyl sulfone, hydrogenation bisphenol A, and water. These active hydrogen group containing compounds can be used independently or in combination unless lowering of preservation stability of ink occurs.

Polycarbonate urethane resin particles are preferable as the polyurethane-based resin particle in terms of water resistance, abrasion resistance, weather resistance, and rub fastness of images, these are caused by high cohesiveness of carbonate group. Ink which is suitable for recording mediums used under severe environment such as outdoor can be obtained by using polycarbonate-based urethane resin particle.

Specific examples of polyurethane resin particles on the market include UCOAT UX-485 (Polycarbonate-type polyurethane emulsion), UCOAT UWS-145 (Polyester-type polyurethane emulsion), PERMARIN UA-368T (Polycarbonate-type polyurethane emulsion), PERMARIN UA-200 (Polyether-type polyurethane emulsion). These products are manufactured by Sanyo Chemical Industries, Ltd. These polyurethane resin particles can be used independently or in combination.

Vinylchloride Resin Particle

It is preferable to use vinylchloride-ethylene copolymer particles and/or vinylchloride-acryl copolymer particles in terms of obtaining miscibility of a pigment and another resin particle included in ink. It is more preferable to use vinylchloride-ethylene copolymer in terms of obtaining high adhesion property with respect to a nonpolar substrate.

Specific examples of the vinylchloride resin particle include, but are not limited to, emulsions on the market such as polyvinylchloride resin emulsion, vinylchloride-acryl copolymer emulsion, and vinylchloride-ethylene copolymer emulsion. These emulsions can be used independently or in combination. Specific examples of the polyvinylchloride resin emulsion include Vinyblan 985 manufactured by Nissin Chemical Industry Co., Ltd. (solid content, 40 mass %, anionic). These polyvinylchloride resin emulsion can be used independently or in combination. Specific examples of the vinylchloride-acryl copolymer emulsion on the market include Vinyblan series manufactured by Nissin Chemical Industry Co., Ltd such as Vinyblan 278 (solid content, 43 mass %, anionic), Vinyblan 700 (solid content, 30 mass %, anionic), Vinyblan 701 (solid content, 30 mass %, anionic), Vinyblan 711 (solid content, 50 mass %, anionic), Vinyblan 721 (solid content, 30 mass %, anionic), Vinyblan 700FS (solid content, 30 mass %, anionic), Vinyblan 701RL35 (solid content, 30 mass %, anionic), Vinyblan 701RL (solid content, 30 mass %, anionic), and Vinyblan 701RL65 (solid content, 30 mass %, anionic). These vinylchloride-acryl copolymer emulsion can be used independently or in combination. Specific examples of vinylchloride-ethylene copolymer emulsion include Smieliete series manufactured by Sumika Chemtex Company, Limited such as Smieliete 1010 (solid content, 50±1 mass %, anionic), Smieliete 1210 (solid content, 50±1 mass %, anionic), and Smieliete 1320 (solid content, 50±1 mass %, anionic). These vinylchloride-ethylene copolymer emulsion can be used independently or in combination. Specific examples of other emulsions on the market include VINNO series manufactured by Wacker Chemie AG such as VINNO E15/48A (solid content, 50 mass %, anionic), and VINNO E22/48A (solid content, 30 mass %, anionic). These emulsions on the market are produced by introducing hydroxyl component to vinylchloride resin and can be used independently or in combination.

Polyester Resin Particles

It is preferable to use a resin particle not having hydrophilic component such as emulsifier or sulfonate in order to avoid remaining the hydrophilic component and in order to obtain water resistance of an image.

Specific examples of polyester resin particles include, are not limited to, a polyester resin particle on the market. Specific examples of the polyester resin particle on the market include emulsion elitel (a registered trademark) series manufactured by UNITIKA LTD, such as KZA-1449 (solid concentration: 30 mass %, anionic), KZA-3556 (solid concentration: 30 mass %, anionic), and KZA-0134 (solid concentration: 30 mass %, anionic); and PESRESIN A Series manufactured by TAKAMATSU OIL&FAT CO., LTD., such as A-124GP (solid concentration: 30 mass %), A125S (solid concentration: 30 mass %), and A-160P (solid concentration: 25 mass %). These polyester resin particles on the market can be used independently or in combination.

Acrylic Resin Particle

Preferable examples of the acrylic resin particle include modified acrylic resin or an acrylic resin particle composed of a copolymer of acryl and at least one kind of other monomers in terms of affinity with respect to pigment particle and recording material.

The acrylic resin particle may be a synthesized or marketed resin. Specific examples of the marketed resin particle include, but are not limited to, Microgel E-1002 and E-5002 (styrene-acrylic particulate resin from Nippon Paint Co., Ltd.), Boncoat 4001 (acrylic particulate resin from DIC Corp.). Boncoat 5454 (styrene-acrylic particulate resin from DIC Corp.), SAE-1014 (styrene-acrylic particulate resin from Zeon Corp.), Saivinol SK-200 (acrylic particulate resin from Saiden Chemical Industry Co., Ltd.), Primal AC-22 and AC-61 (acrylic particulate resin from Rohm and Haas), NANOCRYL SBCX-2821 and 3689 (Acrylic silicone particulate resin from Toyo Ink Mfg. Co., Ltd.), and #3070 (methyl methacrylate polymer particulate resin from Mikuni Color Ltd.)

In the present disclosure, it is preferable to add a resin particle provided in the state of aqueous emulsion as the resin particle, but is not limited to. It is preferable add a resin particle to ink in the state of resin emulsion, that is the state where the resin particle is stably dispersed in water used as disperse medium, in terms of easiness of operations for preparing aqueous ink by combining the resin particle with solvent, coloring agent and water, and in terms of dispersion uniformity of the resin particle in the prepared ink.

In practical use, water soluble organic solvent added to form an ink helps the resin particle to form a film. Heating process therefore is not necessary when the ink of the present disclosure is used because film-formation of the resin particle is promoted by evaporation of solvent and water.

The particulate resin may include a dispersant such as surfactants. The dispersant is preferably a self-emulsifying emulsion because the resultant ink has better film performance. The dispersant preferably includes an anionic group so as to have an acid value of from 5 to 100 mg KOH/g in terms of hydrodispersibility, and more preferably from 5 to 50 mg KOH/g such that the resultant ink has good abrasion resistance and chemical resistance.

Specific examples of anionic group include a carboxyl group, a carboxylate group, and a sulfonic acid group. When the carboxylate group or the sulfonic acid group is used as the anionic group, the resultant dispersant can keep good hydrodispersibility. Monomers having the anionic groups are used to introduce them in a resin.

Specific example of a manufacturing method of water-based dispersion of the resin particle having anion group included addition of basic compound applicable for neutralization of anion group to water-based dispersion. Specific examples of the basic compound include organic amines such as ammonia, triethylamine, pyridine, and morpholine, alkanolamine such as monoethanolamine, and metal basic compound such as Na, K, Li, and Ca. These basic compounds can be used independently or in combination. Surfactant such as nonionic surfactant and anionic surfactant can be used in manufacturing method of water-based dispersion using forcibly emulsify type resin particle.

Specific examples of the nonionic surfactant include polyoxyethylene alkyl ether, polyoxyalkylene alkyl ether, polyoxyethylene derivative, polyoxyethylene fatty acid ester, polyoxyethylene polyhydric alcohol fatty acid ester, polyoxyethylene propylene polyol, sorbitan fatty acid ester, polyoxyethylene hydrogenated castor oil, polyoxyalkylene polycyclic phenyl ether, polyoxyethylene alkylamine, alkylalkanolamide, and polyalkylene glycol (meth) acrylate. polyoxyalkylene alkyl ether, polyoxyethylene fatty acid ester, polyoxyethylene sorbitan fatty acid ester, and polyoxyethylene alkylamine are preferable among these surfactants. Further, these surfactants can be used independently or in combination.

Specific examples of the anionic surfactant include alkyl sulfate ester salt, polyoxyethylenealkyl ether sulfate, alkyl benzene sulfonate, α-olefin sulfonate, methyl tauryl acid salt, sulfosuccinate, ether sulfate, ether carboxylate, fatty acid sodium, formaldehyde condensate of naphthalenesulfonic acid, alkylamine salt, quaternary ammonium salt, and alkyl betaine, alkylamine oxide. The polyoxyethylenealkyl ether sulfate and sulfosuccinate are preferable among these surfactants.

Although the content of surfactant is not particularly limited, preferable values of the surfactant content with respect to the total amount of resin particles is from 0.1 mass % to 30 mass %. More preferable value of the surfactant content with respect to the total amount of resin particles is from 5 mass % to 20 mass %. When the surfactant content is in a rage of from 0.1 mass % to 30 mass %, film forming of the resin particle is preferably conducted, ink having high adhesive property and high water resistance can be obtained, and recording mediums can be used without blocking.

The particulate resin preferably has a volume-average particle diameter of from 10 to 1,000 nm, more preferably from 10 to 200 nm, and furthermore preferably from 10 to 50 nm. The particulate resin having a volume-average particle diameter of from 10 to 50 nm increases contact parts between 2,3-butanediol and the surface of the particulate resin and increases film formability thereof. A tough continuous resin film is formed and a printed matter having high strength is obtained. The volume-average particle diameter can be measured by a particle diameter analyzer Microtrac UPA9340 from NIKKISO CO., LTD.

In the present disclosure, the ink includes at least two kinds of resin particles. A preferable total content of the resin particles is 1 mass % or more but not more than 15 mass % with respect to total amount of the ink, in terms of fixability and stability of the ink. A more preferable total content of the resin particles is 5 mass % or more but not more than 12 mass % with respect to total amount of the ink in terms of improvement of smoothness of the ink layer and high glossiness, and high fixability for a substrate.

Mass Ratio (B/A)

The solid concentration A (mass %) is defined as a solid concentration of resin particles contained in ink in the largest amount among the at least two kinds of resin particles. The total solid concentration B (mass %) is defined as a total solid concentration of resin particles in the ink other than the resin particle contained in ink in the largest amount. A mass ratio (B/A) of from 0.01 to 0.4 is preferable. The mass ratio (B/A) of from 0.05 to 0.3 is more preferable. When the mass ratio (B/A) is 0.01 or more, properties of not only the resin particle contained in ink in the largest amount but also the resin particles in ink other than the resin particle contained in ink in the largest amount can be shown. When the mass ratio (B/A) is 0.4 or less, a continuous layer of the resin particle contained in ink in the largest amount is preferably formed during the ink drying process, and a multiplier effect caused by addition of plural kinds of resin particles can be obtained.

In the present disclosure, at least two kinds of resin particles are contained in the ink. The at least two kinds of resin particles means that the components of the, e.g., two resins are different from one another. Resin particles including the same resin component but being different from each other in weight-average molecular weight are regarded as the same resin particles. When the basic structures of at least two kinds of resins are the same but side chains of at least two kinds of resins are different, these resins are regarded as different kind of resins. Thus, more than one specie of a given overall type of resin particle can be used to satisfy the requirement for “at least two kinds of resin particles”. For example, two different resin particles each having an acrylic backbone can be used as different kinds of resin particles if for example one is made from methyl methacrylate and the other is made from ethyl methacrylate. These two different particles, although they are both acrylic resin particles, would satisfy the requirement for at least two kinds of resin particles. In one embodiment the requirement for at least two kinds of resin particles is satisfied by two distinct classes of resin particles (e.g., not both acrylate-based). This embodiment is referred to herein as “at least two kinds of distinct resin particles”.

The resin particle can be qualitatively or quantitatively analyzed by a method described in the following reference 1, specifically, can be analyzed with the following analyzing apparatus. [Reference 1]“Methods of testing dynamic properties of plastic materials and evaluation results <22>”, Takeo Yasuda, PLASTICS, The Japan Plastics Industry Federation, Editing Committee of “PLASTICS”.

Infrared Spectroscopy (IR)

A resin particle can be qualitatively analyzed by measuring absorption wavelengths of various functional groups in a resin particle and comparing known IR spectrums of resin particles. Further, comparison of absorbance of functional groups in resin particle enables relative amount of several kinds of monomers or resin particles to be compared.

Thermal Analysis (DSC, TG/DTA)

A polymer is identified by measurement of properties such as the glass transition point and the melting point with differential scanning calorimetry (DSC) or differential thermal analysis (DTA).

Pyrolysis Gas Chromatography (PyGC)

A composition analysis or a structural analysis can be conducted by separation of pyrolysis produced products with gas chromatography. More precision analysis can be conducted by identification of pyrolysis produced products with a PyGC directly connected with a mass spectrometer.

Nuclear Magnetic Resonance (NMR)

A resin particle can be identified and confirmed by comparing known spectrums of resin particles. When a resin particle has an unknown spectrum, a molecular structure can be presumed. Further, composition ratio of a copolymer and blend ratio of a polymer blend of plural polymers can be quantitatively analyzed.

Pretreatment such as obtaining supernatant liquid including resin particles by sedimentation of coloring agents with centrifugation method or extraction using preferable solvent is an effective method for improving analytical precision.

Heating after recording leads residual solvent to decrease, then an adhesive property of the ink of the present disclosure can be improved. Particularly, when the minimum film forming temperature (hereinafter referred to as “MFT”) of resin particles is higher than 80° C., the heating is preferable so as to decrease filming defects of resin and improve image fastness.

Adjusting the minimum film forming temperature of resin particles, can be done for example, by controlling the glass transition point (hereinafter referred to as “Tg”) of the resin. Further, controlling the ratio of monomer units included in a copolymer is applicable for the adjustment in case resin particles are copolymer.

In the present disclosure, the minimum film forming temperature is defined as the minimum temperature to form a transparent continuous film when emulsion is flow casted over a metal substrate such as an aluminum substrate and temperature is increased. In a temperature range that is lower than the defined minimum film forming temperature, the temperature at which emulsion turns into white powder is regarded as the minimum film forming temperature. Specifically, the minimum film forming temperature is a value that is measured with a commercially available minimum film forming temperature measuring apparatus such as “Film Forming Temperature Testing Device” (manufactured by IMOTO MACHINERY CO., LTD.) or “TP-801 MF Tester” (manufactured by TESTER SANGYO CO., LTD.). Further, the minimum film forming temperature of resin can be adjusted to be a desired temperature by controlling particulate diameter of the resin.

Mass Ratio (S/C)

The mass content S (mass %) is defined as a mass content of at least one compound of general formulae (1) and (2). The total solid concentration C (mass %) is defined as a total solid concentration of resin particles in the ink. A mass ratio (S/C) of from 0.1 to 2 is preferable. The mass ratio (S/C) of from 0.3 to 1.5 is more preferable. Particularly when the mass ratio (S/C) is from 0.1 to 2, plural kinds of resin particles used in image forming are preferably mixed, discharging performance is stabilized, and high drying property of formed images is presented.

### Organic Solvent

There is no specific limit on the number or types of organic solvent used. For example, a hydrosoluble organic solvent can be used. Specific examples of the hydrosoluble organic solvent include, but are not limited to, polyols such as ethylene glycol, diethylene glycol, 1,2-propane diol, 1,3-propane diol, 1,2-butane diol, 1,3-butane diol, 2,3-butane diol, 3-methyl-1,3-butanediol, 2-methyl-2,4-pentane diol, triethylene glycol, polyethylene glycol, polypropylene glycol, 1,5-pentane diol, 1,6-hexane diol, glycerin, 1,2,6-hexane triol, 2-ethyl-1,3-hexane diol, 1,2,4-butane triol, 1,2,3-butane triol, and petriol; polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, dipropylene glycol monomethyl ether, and propylene glycol monoethyl ether; polyol aryl ethers such as ethylene glycol monophenyl ether and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethylimidazolidinone, ε-caprolactam, and γ-butyrolactone; amides such as formamide, N-methylformamide, and N,N-dimethylformamide; amines such as monoethanolamine, diethanolamine, and triethylamine; sulfur-containing compounds such as dimethyl sulfoxide, sulfolane, and thiodiethanol; propylene carbonate, and ethylene carbonate. Of these, in terms of high glossiness and restraint of aggregation of particle, 1,2-propane diol, 1,3-propane diol, 1,2-butane diol, 1,3-butane diol, 2,3-butane diol, 2-methyl-2,4-pentanediol, and dipropyleneglycol monomethyl ether are preferably used. Further, in terms of high rub fastness, solvent resistance, and promotion of film-forming of resin, a solvent having the boiling point of less than 200° C. (e.g. 1,2-propane diol, 1,2-butane diol, 2,3-butane diol).

The total amount of the organic solvent in the ink is preferably from 20% by mass to 70% by mass and more preferably from 30% by mass to 60% by mass based on total mass of the ink. When the total amount of the organic solvent is 20% by mass or more, the ink is not dried, so that sufficient discharging property is obtained.

### Water

Specific examples of water include, but are not limited to, pure water such as deionized water, ultrafiltration water, reverse osmotic water, distilled water, and hyper pure water. These types of water can be used independently or in combination.

The preferable content of water with respect to the total mass of the ink is from 15 to 60 mass %. More preferable content of the water with respect to the total mass of ink is from 20 to 40 mass %. A content of 15 mass % or more prevents viscosity from being high and improves stability of discharging. A content of 60 mass % or less brings wettability with respect to a substrate having non-osmosis in to suitable and improves quality of image.

### Other Components

Specific examples of other components that can optionally be included in the ink are colorants such as pigments, surfactant, antiseptic mildewproofing agent, antirust agent, pH regulator, and colorless antioxidant for plastic such as hindered phenol and hindered phenol amine.

Pigment

Specific examples of pigment include inorganic pigment and organic pigment. These pigments can be used independently or in combination. Specific examples of the inorganic pigment include titanium oxide, iron oxide, calcium carbonate, barium sulfate, aluminum hydroxide, barium yellow, cadmium red, chrome yellow, and carbon black made by well-known process (e.g. contact method, furnace method, and thermal method). These inorganic pigment can be used independently or in combination. Specific examples of the organic pigment include azo pigment (e.g. azo lake pigment, insoluble azo pigment, condensed azo pigment, and chelate azo pigment), polycyclic pigment (e.g. phthalocyanine pigment, perylene pigment, perinone pigment, anthraquinone pigment, quinacridone pigment, dioxazine pigment, indigo pigment, thioindigo pigment, isoindolinone pigment, quinophthalone pigment), dye chelate (e.g. basic dye chelate and acid dye chelate), nitro pigment, nitroso pigment, and aniline black. These organic pigment can be used independently of in combination. Further, resin hollow particle or inorganic hollow particle can be used. Pigment having high affinity for a solvent is preferably used among the above listed pigment.

Preferable content of the pigment is 0.1 mass % or more but not more than 10 mass % based on total mass of the ink. More preferable content of the pigment is 1 mass % or more but not more than 10 mass %. Image density, fixing property, and discharge stability are improved when the content is in a rage of 0.1 mass % or more but not more than 10 mass %.

Specific examples of pigment for black include carbon blacks (C. 1. Pigment Black 7) such as furnace black, lamp black, acetylene black, and channel black; metals such as copper, iron (C. I. Pigment Black 11), and titanium oxide; and organic pigments such as aniline black (C. 1. Pigment Black 1). These pigment can be used independently or in combination. Examples of the pigment for colors include: C. I. Pigment Yellow 1, 3, 12, 13, 14, 17, 24, 34, 35, 37, 42 (yellow iron oxides), 53, 55, 74, 81, 83, 95, 97, 98, 100, 101, 104, 108, 109, 110, 117, 120, 128, 138, 150, 151, 153, 155, 183, and 213; C. I. Pigment Orange 5, 13, 16, 17, 36, 43, and 51; C. I. Pigment Red 1, 2, 3, 5, 17, 22, 23, 31, 38, 48:2, 48:2 (Permanent Red 2B(Ca)), 48:3, 48:4, 49:1, 52:2, 53:1, 57:1 (Brilliant Carmine 6B), 60:1, 63:1, 63:2, 64:1, 81, 83, 88, 101 (colcothar), 104, 105, 106, 108 (Cadmium Red), 112, 114, 122 (Quinacridone Magenta), 123, 146, 149, 166, 168, 170, 172, 177, 178, 179, 185, 190, 193, 209, and 219; C. I. Pigment Violet 1 (Rhoda mine Lake), 3, 5:1, 16, 19, 23, 38; C. I. Pigment Blue 1, 2, 15 (Phthalocyanine blue), 15:1, 15:2, 15:3 (Phthalocyanine blue), 15:4 (Phthalocyanine blue), 16, 17:1, 56, 60, and 63; and C. I. Pigment Green 1, 4, 7, 8, 10, 17, 18, and 36. These pigment can be used independently or in combination.

Further, self-dispersion pigment, which is added a group (e.g. sulfone group and carboxyl group) on the surface of pigment (e.g. carbon black) and consequently has dispersiveness for water, can be used. Resin fine particle including pigment particle, where pigment is made to be dispersible in water by being included in microcapsule, also can be used. In this case, it is not necessary that all pigment being included in ink is included in the fine resin particle or is adhered to the fine resin particle, the pigment can be dispersed as far as the effect of the present disclosure is not damaged.

The number-average particle diameter is not limited to and preferably has the maximum frequency of 20 nm or more but not more than 150 nm when converted to the maximum number. The diffusion operation and the classification operation become easier when the number-average particle diameter is 20 nm or more. When the number-average particle diameter is 150 nm or less, not only dispersion stability of pigment but also discharge stability and image quality such as image density are improved. The number-average particle diameter is measured by a particle diameter analyzer Microtrac UPA9340 from NIKKISO CO., LTD.

Any kinds of dispersant on the market can be used to disperse pigment by dispersant. Specific examples of dispersant includes polymeric dispersant, and water soluble dispersant. These dispersant can be used independently or in combination.

Surfactant

Surfactant can be included so as to obtain wettability for a recording medium. The surfactant is preferably selected from those having low surface tension, high penetration ability and high leveling ability, provided that it does not impair the dispersion stability depending on a combination with the colorant for use, or the wetting agent for use. The surfactant is preferably at least one selected from the group consisting of an anionic surfactant, a nonionic surfactant, a silicone surfactant, and a fluorosurfactant. Among them, the silicone surfactant, the fluorosurfactant, an acetylene glycol or acetylene alcohol surfactant are particularly preferable. These surfactants may be used independently, or in combination.

Specific examples of nonionic surfactants include, but are not limited to, polyoxyethylene alkyl ether, polyoxyethylene alkylene alkyl ether, polyoxyethylene derivatives, polyoxyethylene aliphatic acid esters, polyoxyethylene polo) aliephatic acid ester, polyoxyethylene propylene polyol, sorbitan aliphatic, acid ester, polyoxyethylene curable ricinus, polyoxyalkylene polycyclic phenyl ether, polyoxyethylene alkyl amine, alkyl alkanol amide, and polyalkylene glycol (meth)acrylate. Of these, polyoxyethylene alkyl ether, polyoxyethylene aliphatic acid esters, polyoxyethylene sorbitan aliphatic acid ester, and polyoxyethylene alkyl amine.

Preferable content of the surfactant is from 0.1 mass % to 5 mass % based on total mass of the ink. When the content of the surfactant is 0.1 mass % or more, wettability with respect to a substrate having non-osmosis can be obtained, and therefore, image quality can be improved. When the content of the surfactant is 5 mass % or less, bubbles are hard to be generated from ink, and therefore, excellent stability of discharging can be obtained.

Antiseptic Mildewproofing Agent

Specific examples of antiseptic mildewproofing agent include 1,2-benzisothiazolin-3-one, sodium benzoate, sodium dehydroacetate, sorbic acid sodium salt, sodium pentachlorophenolate, and 2-pyridinethiol-1-oxide sodium salt. These antiseptic mildewproofing agents can be used independently or in combination.

Antirust Agent

Specific examples of the antirust agent includes acidity sulfites, sodium thiosulfate, ammonium thiodiglycolate, diisopropyl ammonium nitrate, pentaerythritol tetrahydrochloride, and decyclohexyl ammonium nitrate. These antirust agents can be used independently or in combination.

pH Regulator

The pH regulator is not limited to. Any material can be used as the pH regulator so far as it can regulate pH value as desired value without harmful effect on ink. Specific examples of pH regulator includes alkali metal element hydroxide such as lithium hydroxide, sodium hydroxide, and potassium hydroxide, alkali metal element carbonate such as lithium carbonate, sodium carbonate, and potassium carbonate, amine such as quaternary ammonium hydroxides, diethanolamine, and triethanolamine, ammonium hydroxide, and quaternary phosphonium hydroxide. These pH regulator can be used independently or in combination.

The ink of the present disclosure can be suitably used for ink-jetting or the like.

### Ink Manufacturing Method

The disclosed ink, for example, can be manufactured by the following method: dispersing or dissolving water, organic solvent, resin particles, and the other components as necessary in water, and then stirring and mixing as necessary. Specific examples of stirring and mixing equipment includes a sand mill, a homogenizer, a ball mill, a paint shaker, an ultrasonic disperser, a general mixer using impeller, a magnetic stirrer, and a high speed disperser.

Viscosity

A preferable viscosity of the ink is 2 mPa·s or more at 25° C. More preferable viscosity of the ink is 3 mPa·s or more but not more than 20 mPa·s at 25° C. Stability of discharge can be improved when the viscosity is 2 mPa·s or more.

### Recording Medium

Specific examples of the recording medium includes an osmosis substrate and a substrate having non-osmosis.

Ink Cartridge

The ink cartridge includes an ink cartridge containing black ink in a container, and an ink cartridge containing color ink in a container. The ink cartridge is configured as having a container containing the ink and further having the other equipment as necessary.

Shape, structure, and material of the container is not limited to, and can be selected in accordance with the situation. Specific examples of the container includes a container having an ink bag made of aluminum laminated film, resin film, or the like.

Ink-Jetting Recording Method

The ink-jetting recording method of the present disclosure includes an ink flashing process where an image is created by flashing an ink onto a recording medium. This process preferably includes a heating process.

Ink Flashing Process

The ink flashing process is a process where the ink is stimulated and flashed with the result that an image is created. The stimulation is not limited and can be selected in accordance with the situation. Specific examples of the stimulation includes heat (temperature), pressure, oscillation, and light. These stimulation can be used independently or in combination. Heat and pressure are preferably used.

The ink of the present disclosure can also be used in any printer having a piezoelectric element type in which ink droplets are discharged by transforming a vibration plate that forms the wall of the ink flowing path using a piezoelectric element as a pressure generating device to press the ink in the ink flowing path as described in JP-H2-51734-A; a thermal type in which bubbles are produced by heating ink in the ink flowing path with a heat element as described in JP-S61-59911-A; and an electrostatic type in which ink droplets are discharged by changes of the volume in the ink flowing path caused by transforming a vibration plate that forms the wall surface of the ink flowing path by a force of electrostatic generated between the vibration plate and the electrode while the vibration plate and the electrode are provided facing each other as described in JP-H6-71882-A. Of these, the ink is particularly suitable for the piezoelectric element type.

Preferable size of a droplet of the ink being discharged is 3 pl or more but not more than 40 pl. Preferable jet velocity of the ink being discharged is 5 m/s or more but not more than 20 m/s. Preferable drive frequency for jetting the ink is 1 kHz or more. Preferable printing resolution is 300 dpi or more.

Heating Process

The heating process is a process where image recorded medium is heated. The ink-jetting recording method can record high quality image on a substrate having non-osmosis, however it is preferable to heat the substrate having non-osmosis so as to create higher quality image, higher rub fastness, and higher adhesiveness and so as to conduct under rapid recording condition.

Specific examples of equipment for heating process includes a forced-air heating, a radiation heating, a conduction heating, a high-frequency dryer, and a microwave dryer. These equipment can be used independently or in combination. Heating temperature can be adjusted in accordance with kinds of water soluble organic solvent, amount of water soluble organic solvent, or minimum film forming temperature of added resin emulsion. It is preferable that the heating temperature is such high as 40° C. to 120° C. It is more preferable that the heating temperature is 50° C. to 90° C. Heat damages of a substrate having non-osmosis and misfiring caused by warming of ink head are prevent when the heating temperature is in a range of 40° C. to 120° C.

Recording methods of the present disclosure can includes a recording method having the step of applying clear ink not including pigment and ink including white pigment as a coloring agent onto a recording medium and the recording by ink including pigment. The clear ink or the white ink can be applied onto the whole surface of the recording medium or onto a part of the recording medium. When the clear ink or the white ink is applied onto a part of the recording medium, these inks can be applied the same portion as the recording portion or a portion in common with the recording portion.

When white ink is used, the following recording method can be used: applying the white ink onto the recording medium, and then recording on the applied recording medium by ink having the other color than white. By this, even though a transparent film is used, visibility of record can be obtained because the white ink of the present disclosure is adhered on the surface of the recording medium. The white ink of the present disclosure can be applied onto a substrate having non-osmosis so as to improve visibility because the white ink of the present disclosure has preferable drying property, high glossiness, and rub fastness for the substrate having non-osmosis.

Further, image having high visibility can be obtained by applying the white ink after recording on the transparent film. If the clear ink is used instead of the white ink, the clear ink can work as a protective layer.

The ink of the present disclosure is not limited to the ink-jetting recoding methods, and can be used in other recording methods, etc. (e.g. blade coating methods, gravure coating methods, gravure offset coating methods, bar coating methods, roll coating methods, knife coating methods, air knife coating methods, comma coating methods, U comma coating methods, AKKU coating methods, smoothing coating methods, micro gravure coating methods, reverse roll coating methods, 4 or 5-roll coating methods, curtain coating methods, slide coating methods, die coating methods). One embodiment of the present disclosure includes the steps of applying by another method than the ink-jetting recording method when applying a white ink onto the whole of recording medium, and recording by using the ink-jetting method when recording by the ink other than the white ink. Another embodiment of the present disclosure includes the step of recording by the ink-jetting method for both the white ink and the other colored ink than the white ink. The same is the case using the clear ink instead of the white ink.

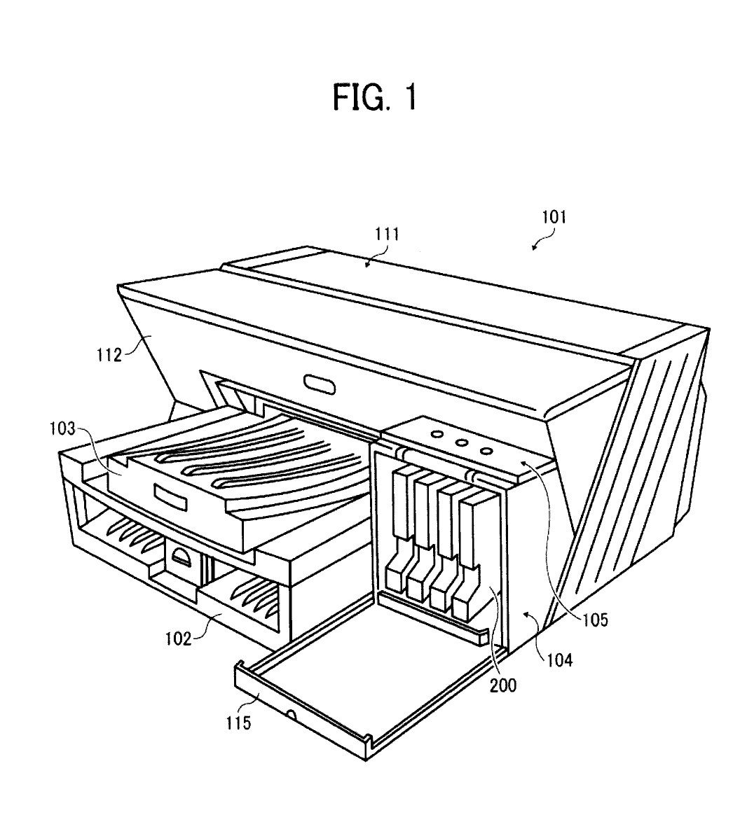

An inkjet recording device that is capable of recording using the ink of the present disclosure is described in detail with reference to the accompanying drawings. A recording method using a substrate having non-osmosis is described, but recording on a substrate without such difficulty is conducted in a similar manner. Furthermore, the inkjet recording device includes a serial type (shuttle type) in which a carriage scans and a line type having a line type head. FIG. 1 is a schematic diagram illustrating an example of a serial type inkjet recording device.

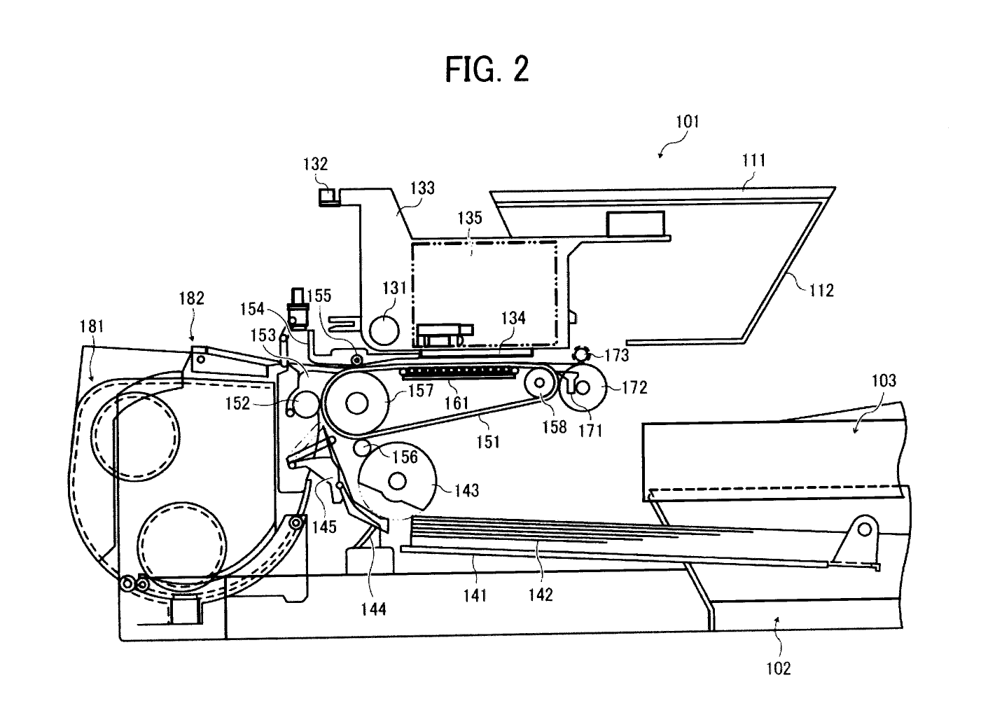

As shown in FIG. 1, the inkjet recording device has a main body 101, a sheet feeding tray 102 installed onto the main body 101, a discharging tray 103, and an ink cartridge inserting portion 104. On the upper surface of the ink cartridge inserting portion 104 is arranged an operating unit 105 such as operation keys and a display. The ink cartridge inserting portion 104 has a front cover 115 that is openable and closable to detach and attach an ink cartridge 201. “111” represents an upper cover and “112” represents the front of the front cover. Inside the main body 101, as shown in FIG. 2, a guide rod 131 serving as a guiding member that laterally bridges side plates provided on the right side and left side and a stay 132 hold a carriage 133 slidably movable in the main scanning direction. A main scanning motor moves the carriage 133 for scanning.

The carriage 133 has a recording head 134 having four inkjet recording heads that discharge ink droplets of each color of yellow (Y), cyan (C), magenta (M), and black (Bk) while multiple ink discharging mouths are arranged in the direction crossing the main scanning direction with the ink droplet discharging direction downward.

As the heads for inkjet recording that form the recording head 134, it is possible to use a device having an energy-generating device to discharge ink such as a piezoelectric actuator such as a piezoelectric element, a thermal actuator that utilizes the phase change caused by film boiling of liquid using an electric heat conversion element such as a heat element, a shape-memory alloy actuator that uses the metal phase change due to the temperature change, and an electrostatic actuator that uses an electrostatic force.

The carriage 133 has sub tanks 135 for colors to supply each color ink to the recording head 134. The ink for inkjet recording of the present disclosure is supplied and replenished to the sub tank 135 from the ink cartridge 201 mounted onto the ink cartridge inserting unit 104 via a tube for supplying ink.

A sheet feeding unit to feed a sheet 142 loaded on a sheet loader (pressure plate) 141 of the sheet feeder tray 102 includes a half-moon shape roller (sheet feeding roller 143) to separate and feed the sheet 142 one by one from the sheet loader 141 and a separation pad 144 that is made of a material having a large friction index and arranged facing the sheet feeding roller 143 while biased to the side of the sheet feeding roller 143.

A transfer unit to transfer the sheet 142 fed from the sheet feeding unit on the lower side of the recording head 134 includes a transfer belt 151 to electrostatically adsorb and transfer the sheet 142, a counter roller 152 to transfer the sheet 142 fed from the sheet feeding unit via a guide 145 while pinching the sheet 142 with the transfer belt 151, a transfer guide 153 to make the sheet 142 track on the transfer belt 151 by changing the transfer direction of the sheet 142 being sent substantially vertically upward by substantially 90°, a front end pressure roller 155 biased towards the transfer belt 151 by a pressure member 154, and a charging roller 156 to charge the surface of the transfer belt 151.

The transfer belt 151 has an endless form, stretched between a transfer roller 157 and a tension roller 158 and rotatable in the belt transfer direction. This transfer belt 151 include, for example, a top layer serving as a non-porous substrate adsorption surface made of a resin material such as a copolymer (ETFE) of tetra fluoroethylene and ethylene with no resistance control treatment while having a thickness about 40 μm and a bottom layer (moderate resistance layer, earth layer) made of the same material as the top layer with resistance control treatment with carbon.

On the rear side of the transfer belt 151, a guiding member 161 is arranged corresponding to the printing area by the recording head 134. A discharging unit to discharge the sheet 142 on which images are recorded by the recording head 134 includes a separation claw 171 to separate the sheet 142 from the transfer belt 151, a discharging roller 172, and a discharging roller 173.

The sheet 142 is dried by heat wind by a fun heater 174 and thereafter output to a discharging tray 103 arranged below the discharging roller 172.

The duplex printing sheet feeding unit 181 takes in and reverses the sheet 142 that is returned by the reverse rotation of the transfer belt 151 and feeds it again between the counter roller 152 and the transfer belt 151. A manual sheet feeding unit 182 is provided on the upper surface of the duplex printing sheet feeding unit 181.

In this inkjet recording device, the sheet 142 is separated and fed from the sheet feeding unit one by one substantially vertically upward, guided by the guide 145, and transferred while being pinched between the transfer belt 151 and the counter roller 152.

Furthermore, the front end is guided by the transfer guide 153 and pressed against the transfer belt 151 by the front end pressure roller 155 to change the transfer direction substantially 90°. Since the transfer belt 157 is charged by the charging roller 156 at this point in time, the sheet 142 is electrostatically adsorbed to the transfer belt 151 and transferred.

By driving the recording head 134 according to the image signal while moving the carriage 133, the ink droplet is discharged to the sheet 142 not in motion to record an image for an amount corresponding to one line and thereafter the sheet 142 is transferred in a predetermined amount to conduct recording for the next line. On receiving a signal indicating that the recording completes or the rear end of the sheet 142 has reached the image recording area, the recording operation stops and the sheet 142 is discharged to the discharging tray 103.

Record

The record of the present disclosure has an image recorded by the ink on the recording medium. Specific examples of the recording medium include, but are not limited to, plain paper, glossy paper, special paper, and fabric. The ink of the present disclosure can provide an image having excellent coloring even though the ink is used for a substrate having non-osmosis. The substrate having non-osmosis is a substrate having low water permeability, low absorbability, and/or low adhesive surface. Examples of the substrate having non-osmosis include a substrate having a lot of pores inside but not permitting osmosis from outside, that is, a substrate whose amount of water absorption at between the beginning of contact and 30 msec^{1/2} is 10 mL/m² or less when examined with the Bristow method. Specific examples of the substrate having non-osmosis include a plastic film such as a vinyl chloride resin film, a PET film, and a polycarbonate film. However, the ink of the present disclosure can be used effectively on substrates having non-osmosis and on conventional osmosis substrates such as an inorganic coated osmosis substrate.

A colored recording medium colored by applying white ink has white color on the whole surface and can improve color development property of color ink. Specific examples of the colored recording medium include colored paper, colored film, colored fabric, colored clothes, and colored ceramic.

### EXAMPLES

The present disclosure is explained more concretely by showing practical examples and comparative examples, but not limited to these practical examples. It is noted that the term “parts” stands for “mass parts” and that the term “%” stands for “mass %” except for being used in evaluation standards.

### Preparation of a Resin Particle

Preparation Example of Polycarbonate-Based Urethane Resin Emulsion 1

1,500 g of polycarbonatediol (a reactant of 1,6-hexandiol dimethyl and carbonate ((Mn):1200)), 220 g of 2,2-dimethylolpropionic acid (hereinafter called “DMPA”), and 1,347 g of N-methylpyrrolidone (hereinafter called “NMP”) were introduced to a reactor being provided with a stirrer, a circulation condenser tube, and a thermometer under a nitrogen gas stream, and then, DMPA was dissolved with heating of 60° C. Urethanation reaction was conducted for 5 hours by adding 1,445 g of 4-4′dicyclohexylmethane diisocyanate and 2.6 g of dibutyltin laurate (catalyst) to the reactor which was heated to 90° C. after the addition. By this, isocyanate terminated urethane prepolymer was obtained. 4,340 g of mixture, which is taken out from the above reaction mixture that was cooled to 80° C., then added 149 g of triethylamine and mixtured, was added to mixture of 5,400 g of water and 15 g of triethylamine. Further, 1,500 g of ice was added, chain elongation reaction was conducted by adding 626 g of 35% solution of 2-methyl-1,5-pentanediamin, solvent was removed so as to be 30% of solid content concentration. By this, polycarbonate-based urethane resin emulsion was obtained. The minimum film forming temperature of the polycarbonate-based urethane resin emulsion measured with “Film Forming Temperature Testing Device” (manufactured by IMOTO MACHINERY CO., LTD.) was 55° C.

Preparation Example of Polyether-Based Urethane Resin Emulsion 2

100.2 parts of polyetherpolyol (“PTMG1000” manufactured by Mitsubishi Chemical Corporation, mean molecular weight: 1,000), 15.7 parts of 2,2-dimethylolpropionic acid, 48.0 parts of isophorone diisocyanate, 77.1 parts of methyl ethyl ketone as an organic solvent, and 0.06 parts of dibutyltin laurate as a catalyst (hereinafter called “DMTDL”) were reacted in a nitrogen purged reactor being provided with a thermometer, a nitrogen gas introducing tube, and a stirrer.

30.7 parts of methyl ethyl ketone were added as a diluting solvent after continuing the reaction for 4 hours, and the reaction was further continued.

The reaction was stopped by addition of 1.4 parts of methanol when the mean molecular weight of the reactant reached in the range of 20,000 to 60,000, by this, organic solvent of urethane resin was obtained.

Carboxy group of the urethane resin was neutralized by addition of 13.4 parts of 48% potassium hydroxide solution to the organic solvent of urethane resin, and 30 mass % solid content polyether-based urethane resin emulsion was obtained by aging and removing of solvent after addition of 715.3 parts of water and sufficient stirring.

The minimum film forming temperature of the polyether-based urethane resin emulsion measured with “Film Forming Temperature Testing Device” (manufactured by IMOTO MACHINERY CO., LTD.) in a similar manner to the preparation example of polycarbonate-based urethane resin emulsion 1 was 43° C.

Preparation Example of Polyester-Based Urethane Resin Emulsion 3

30 mass % solid content polyester-based urethane resin emulsion was obtained in a similar manner to the preparation example of polyether-based urethane resin emulsion 2 with the exception of that polyetherpolyol (“PTMG1000” manufactured by Mitsubishi Chemical Corporation, mean molecular weight: 1,000) was substituted by polyesterpolyol (“Polylite OD-X-2251” DIC Corporation, mean molecular weight: 2,000).

The minimum film forming temperature of the polyester-based urethane resin emulsion measured with “Film Forming Temperature Testing Device” (manufactured by IMOTO MACHINERY CO., LTD.) in a similar manner to the preparation example of polycarbonate-based urethane resin emulsion 1 was 74° C.

Preparation Example of Acrylic Resin Emulsion 4

900 g of ion exchanged water and 1 g of sodium lauryl sulfate were contained in a reactor being provided with a stirrer, a circulation condenser, a dropping device, and a thermometer, the reactor was heated to 70° C. with stirring.

Emulsion, which was produced by addition of 20 g of acrylamide, 615 g of styrene, 30 g of butylacrylate and 350 g of methacrylic acid to 450 g of ion exchanged water and 3 g of sodium lauryl sulfate under stirring, was dropped continuously to the reaction solution for 4 hours. After the dropping, reaction was conducted for 3 hours, then aqueous emulsion was obtained.

Ion exchanged water and sodium hydroxide aqueous solution were added after the obtained aqueous emulsion was cooled to normal temperature, then acrylic resin emulsion of 30 mass % solid content and pH8 was obtained.

The minimum film forming temperature of the acrylic resin emulsion measured with “Film Forming Temperature Testing Device” (manufactured by IMOTO MACHINERY CO., LTD.) in a similar manner to the preparation example of polycarbonate-based urethane resin emulsion 1 was 53° C.

Preparation of a Pigment Dispersion

Preparation Example of a Black Pigment Dispersion 1

A blend of components listed below were premixed and circulatory dispersed with disk type bead mill (KDL type manufactured by Shinmaru Enterprises Corporation, Media: using 0.3 mm diameter zirconia balls) for 7 hours, then black pigment dispersion was obtained.

Carbon black pigment (Product name: Monarch 800, manufactured by Cabot Corporation Foundation, Inc.): 15 parts Anionic surfactant (Pionin A-51-B, TAKEMOTO OIL & FAT Co., Ltd.):2 parts Ion exchanged water:83 parts

Preparation Example of a Cyan Pigment Dispersion 2

A cyan pigment dispersion was obtained in a similar manner to the preparation example of a black pigment dispersion 1 with the exception of that carbon black pigment was substituted by pigment blue (Product name: LIONOL BLUE FG-7351, manufactured by TOYO INK CO., LTD.)

Preparation Example of a Magenta Pigment Dispersion 3

A magenta pigment dispersion was obtained in a similar manner to the preparation example of a black pigment dispersion 1 with the exception of that carbon black pigment was substituted by pigment red 122 (Product name: Toner Magenta E002, manufactured by Clariant (Japan) K.K.)

Preparation Example of a Yellow Pigment Dispersion 4

A yellow pigment dispersion was obtained in a similar manner to the preparation example of a black pigment dispersion 1 with the exception of that carbon black pigment was substituted by pigment yellow-74 (Product name: Fast Yellow-531, manufactured by Dainichiseika Color & Chemicals Mfg. Co., Ltd.)

Preparation Example of a White Pigment Dispersion 5

A blend of 25 parts of titanium oxide (Product name: STR-100W, manufactured by SAKAI CHEMICAL INDUSTRY CO., LTD.), 5 parts of pigment dispersant (Product name: TEGO Dispers 651, manufactured by Evonik Industries AG), and 70 parts of water was prepared, and 0.3 mmφ of zirconia beads were dispersed with a bead mill (Product name: Research Lab, manufactured by Shinmaru Enterprises Corporation) at a filling ratio of 60% and 8 m/s, then a white pigment dispersion was obtained.

### Example 1

### Preparation of Black Ink 1

The solution including black pigment dispersion at 20%, polycarbonate-based urethane resin emulsion (solid content: 30%) at 33.33%, vinyl chloride resin particle (product name: VINNOL E15/48A, manufactured by Wacker Chemie AG, solid content: 50%) at 1%, 1,2-propanediol at 12%, 1,2-butandiol at 10%, 2-methyl-2,4-pentanediol at 3%, 3-methoxy-N,N-methylpropionamide (product name: Equamide M-100, manufactured by Idemitsu Kosan Co., Ltd.) at 5%, antiseptic (product name: proxel LV, manufactured by Avecia) at 0.1%, surfactant (product name: SOFTANOL EP-5035, manufactured by NIPPON SHOKUBAI CO., LTD.) at 0.01%, high purity water at 15.56% was mixed and stirred, and then was filtrated with a 0.2 μm polypropylene filter, consequently, the ink 1 was made.

### Examples 2-19, and Comparative Examples 1-5

As for Examples 2-19, and Comparative examples 1-5, inks 2-24 were prepared in a similar manner to Example 1 with the exception of that composition and content ratio were modified as listed in Tables 1-4. The composition and the content ratio of Example 2-19, and Comparative example 1-5 are shown in Tables 1-4.

TABLE 1

| | | Example | | | | | | |
|---|---|---|---|---|---|---|---|---|
| | | 1 | 2 | 3 | 4 | 5 | 6 | 7 |
| Ink No. | | 1 | 2 | 3 | 4 | 5 | 6 | 7 |
| Pigment | Black Pigment Despersion | 20 | 20 | | | 20 | 20 | |
| | Cyan Pigment Despersion | | | | | | | 18 |
| | Magenta Pigment Despersion | | | 20 | | | | |
| | Yellow Pigment Despersion | | | | 15 | | | |
| | White Pigment Despersion | | | | | | | |
| Resin Particle | polycarbonate-based urethane resin emulsion | 33.33 | 33.33 | | | | 33.33 | 25 |
| | polyether-based urethane resin emulsion | | | 33.33 | 50 | | | |
| | polyester-based urethane resin emulsion | | | | | 25 | | |
| | vinylchloride resin emulsion | 1 | | 3 | 1 | | | |
| | vinyl chloride-ethylene copolymer | | 3 | | | 6 | 6 | |
| | Vinyl chloride-acryl copolymer | | | | | | | 2 |
| | polyester emulsion | | | | | | | |
| | acrylic resin emulsion | | | | | | | 4 |
| Compound of | 3-methoxy-N,N-dimethylpropanamide | 5 | 5 | 3 | 10 | 15 | | |
| the general | 3-butoxy-N,N-dimethylpropionamide | | 5 | | | | 10 | |
| formula (1) | | | | | | | | |
| Compound of | 3-methyl-3-oxetanemethanol | | | | | | | 15 |
| the general | 3-ethyl-3-oxetanemethanol | | | | | | | |
| formula (1) | | | | | | | | |
| Organic Solvent | 1,2-propanediol | 12 | 20 | 20 | 15 | 16 | 20 | 10 |
| | 1,2-butanediol | 10 | | 2 | | | | |
| | 2,3-butanediol | | | 2 | | | 2 | 5 |
| | 2-methyl-2,4-pentane diol | 3 | | 2 | 2 | | | 2 |
| | dipropylene glycol monomethyl ether | | | 1 | | 3 | 2 | 2 |
| cofactor | Proxel LV | 0.1 | 0.1 | 0.1 | 0.1 | 0.1 | 0.1 | 0.1 |
| | Surfactant | 0.01 | 0.01 | 0.01 | 0.01 | 0.01 | 0.01 | 0.01 |
| | High pure water | residual | residual | residual | residual | residual | residual | residual |
| | | quantity | quantity | quantity | quantity | quantity | quantity | quantity |

| | | | | | | | |
|---|---|---|---|---|---|---|---|
| Total amount (mass %) | 100 | 100 | 100 | 100 | 100 | 100 | 100 |
| the solid concentration A (mass %) of the resin particle | 10 | 10 | 10 | 15 | 8 | 10 | 8 |
| included in the ink at largest amount | | | | | | | |
| the total solid concentration B (mass %) of the other resin | 0.5 | 1.5 | 1.5 | 0.5 | 3 | 3 | 2 |
| particles than the resin particle included in the ink | | | | | | | |
| at largest amount | | | | | | | |
| the mass content S (mass %) of the at least one compound | 5 | 10 | 3 | 10 | 15 | 10 | 15 |
| selected from the group consisting of thegeneral | | | | | | | |
| formulae (1) and (2) | | | | | | | |
| total solid concentration C (mass %) of the resin particles | 10.5 | 11.5 | 11.5 | 15.5 | 10.5 | 13 | 10 |
| mass ratio (B/A) | 0.05 | 0.15 | 0.15 | 0.03 | 0.4 | 0.3 | 0.29 |
| mass ratio (S/C) | 0.48 | 0.87 | 0.26 | 0.65 | 1.43 | 0.77 | 1.25 |

TABLE 2

| | | Example | | | | | | |
|---|---|---|---|---|---|---|---|---|
| | | 8 | 9 | 10 | 11 | 12 | 13 | 14 |
| Ink No. | | 8 | 9 | 10 | 11 | 12 | 13 | 14 |
| Pigment | Black Pigment Despersion | | 22 | | | 20 | | |
| | Cyan Pigment Despersion | 20 | | 23 | 20 | | 20 | 20 |
| | Magenta Pigment Despersion | | | | | | | |
| | Yellow Pigment Despersion | | | | | | | |
| | White Pigment Despersion | | | | | | | |
| Resin Particle | polycarbonate-based urethane resin emulsion | | 33.33 | | | | 33.33 | |
| | polyether-based urethane resin emulsion | 25 | | | | | | |
| | polyester-based urethane resin emulsion | | | 33.33 | 33.33 | 33.33 | | 33.33 |
| | vinylchloride resin emulsion | | | | | | | |
| | vinyl chloride-ethylene copolymer | | | | | | | |
| | Vinyl chloride-acryl copolymer | 3 | | | | | | |
| | polyester emulsion | 2 | 3.33 | 3.33 | 6.67 | 6.67 | | |
| | acrylic resin emulsion | | | | | | 3.33 | 3.33 |
| Compound of | 3-methoxy-N,N-dimethylpropanamide | | 5 | 5 | 20 | | 5 | 8 |
| the general | 3-butoxy-N,N-dimethylpropionamide | | | | | | | |
| formula (1) | | | | | | | | |
| Compound of | 3-methyl-3-oxetanemethanol | | | 5 | | 15 | | 2 |
| the general | 3-ethyl-3-oxetanemethanol | 15 | | | | | | |
| formula (1) | | | | | | | | |
| Organic Solvent | 1,2-propanediol | 20 | 18 | 18 | 12 | 15 | 16 | 18 |
| | 1,2-butanediol | | 5 | 2 | 1 | | 2 | |
| | 2,3-butanediol | | 2 | 2 | | 1 | 5 | 2 |
| | 2-methyl-2,4-pentane diol | | 2 | | | | 2 | |
| | dipropylene glycol monomethyl ether | | 2 | | | 1 | 2 | 2 |
| cofactor | Proxel LV | 0.1 | 0.1 | 0.1 | 0.1 | 0.1 | 0.1 | 0.1 |
| | Surfactant | 0.01 | 0.01 | 0.01 | 0.01 | 0.01 | 0.01 | 0.01 |
| | High pure water | residual | residual | residual | residual | residual | residual | residual |
| | | quantity | quantity | quantity | quantity | quantity | quantity | quantity |

| | | | | | | | |
|---|---|---|---|---|---|---|---|
| Total amount (mass %) | 100 | 100 | 100 | 100 | 100 | 100 | 100 |
| the solid concentration A (mass %) of the resin particle | 8 | 10 | 10 | 10 | 10 | 10 | 10 |
| included in the ink at largest amount | | | | | | | |
| the total solid concentration B (mass %) of the other | 2 | 1 | 1 | 2 | 2 | 1 | 1 |
| resin particles than the resin particle included | | | | | | | |
| in the ink at largest amount | | | | | | | |
| the mass content S (mass %) of the at least one compound | 15 | 5 | 10 | 20 | 15 | 5 | 10 |
| selected from the group consisting of thegeneral | | | | | | | |
| formulae (1) and (2) | | | | | | | |
| total solid concentration C (mass %) of the resin particles | 10 | 11 | 11 | 12 | 12 | 11 | 11 |
| mass ratio (B/A) | 0.28 | 0.1 | 0.1 | 0.2 | 0.2 | 0.1 | 0.1 |
| mass ratio (S/C) | 1.25 | 0.45 | 0.91 | 1.67 | 1.25 | 0.45 | 0.91 |

TABLE 3

| | | Example | | | | |
|---|---|---|---|---|---|---|
| | | 15 | 16 | 17 | 18 | 19 |
| Ink No. | | 15 | 16 | 17 | 18 | 19 |
| Pigment | Black Pigment Despersion | 20 | | | 22 | |
| | Cyan Pigment Despersion | | 20 | 22 | | |
| | Magenta Pigment Despersion | | | | | |
| | Yellow Pigment Despersion | | | | | |
| | White Pigment Despersion | | | | | 20 |
| Resin Particle | polycarbonate-based urethane resin emulsion | 33.33 | | | | 33.33 |
| | polyether-based urethane resin emulsion | | | | | |
| | polyester-based urethane resin emulsion | | | | | |
| | vinylchloride resin emulsion | | | | | |
| | vinyl chloride-ethylene copolymer | | | | | 3 |
| | Vinyl chloride-acryl copolymer | | 2 | 20 | | |
| | polyester emulsion | | 33.33 | | 3.33 | |
| | acrylic resin emulsion | 6.67 | | 3.33 | 33.33 | |
| Compound of | 3-methoxy-N,N-dimethylpropanamide | 10 | 5 | 5 | 5 | 10 |
| the general | 3-butoxy-N,N-dimethylpropionamide | | | | | |
| formula (1) | | | | | | |
| Compound of | 3-methyl-3-oxetanemethanol | | | | | |
| the general | 3-ethyl-3-oxetanemethanol | 5 | | | | |
| formula (1) | | | | | | |
| Organic Solvent | 1,2-propanediol | 18 | 22 | 22 | 15 | 20 |
| | 1,2-butanediol | | 2 | 2 | 4 | |
| | 2,3-butanediol | | | 4 | 2 | |
| | 2-methyl-2,4-pentane diol | | 2 | 2 | 2 | |
| | dipropylene glycol monomethyl ether | | | 2 | 5 | |
| cofactor | Proxel LV | 0.1 | 0.1 | 0.1 | 0.1 | 0.1 |
| | Surfactant | 0.01 | 0.01 | 0.01 | 0.01 | 0.01 |
| | High pure water | residual | residual | residual | residual | residual |
| | | quantity | quantity | quantity | quantity | quantit |

| | | | | | |
|---|---|---|---|---|---|
| Total amount (mass %) | 100 | 100 | 100 | 100 | 100 |
| the solid concentration A (mass %) of the resin particle | 10 | 10 | 10 | 10 | 10 |
| included in the ink at largest amount | | | | | |
| the total solid concentration B (mass %) of the other resin | 2 | 1 | 1 | 1 | 1.5 |
| particles than the resin particle included in the ink at largest | | | | | |
| amount | | | | | |

TABLE 4

| | | Comparative Example | | | | |
|---|---|---|---|---|---|---|
| | | 1 | 2 | 3 | 4 | 5 |
| Ink No. | | 20 | 21 | 22 | 23 | 24 |
| Pigment | Black Pigment Despersion | 20 | 20 | 20 | 20 | 20 |
| | Cyan Pigment Despersion | | | | | |
| | Magenta Pigment Despersion | | | | | |
| | Yellow Pigment Despersion | | | | | |
| | White Pigment Despersion | | | | | |
| Resin Particle | polycarbonate-based urethane resin emulsion | 33.33 | | 33.33 | | |
| | polyether-based urethane resin emulsion | | | | | |
| | polyester-based urethane resin emulsion | | | | | |
| | vinylchloride resin emulsion | 1 | 25 | | | |
| | vinyl chloride-ethylene copolymer | | | | | |
| | Vinyl chloride-acryl copolymer | | | | | |
| | polyester emulsion | | | | 23 | |
| | acrylic resin emulsion | | | | | 33.33 |
| Compound of | 3-methoxy-N,N-dimethylpropanamide | | 10 | | | 15 |
| the general | 3-butoxy-N,N-dimethylpropionamide | | | | | |
| formula (1) | | | | | | |
| Compound of | 3-methyl-3-oxetanemethanol | | | 5 | 10 | |
| the general | 3-ethyl-3-oxetanemethanol | | | | | |
| formula (1) | | | | | | |
| Organic Solvent | 1,2-propanediol | 20 | 20 | 20 | 15 | 16 |
| | 1,2-butanediol | 10 | | 2 | 5 | |
| | 2,3-butanediol | | 2 | 2 | 5 | |
| | 2-methyl-2,4-pentane diol | 3 | 4 | 2 | 2 | |
| | dipropylene glycol monomethyl ether | | | 1 | | 3 |
| cofactor | Proxel LV | 0.1 | 0.1 | 0.1 | 0.1 | 0.1 |
| | Surfactant | 0.01 | 0.01 | 0.01 | 0.01 | 0.01 |
| | High pure water | residual | residual | residual | residual | residual |
| | | quantity | quantity | quantity | quantity | quantity |

| | | | | | |
|---|---|---|---|---|---|
| Total amount (mass %) | 100 | 100 | 100 | 100 | 100 |
| the solid concentration A (mass %) of the resin particle | 10 | 13 | 10 | 7 | 10 |
| included in the ink at largest amount | | | | | |
| the total solid concentration B (mass %) of the other | 0.3 | — | — | — | — |
| resin particles than the resin particle included in | | | | | |
| the ink at largest amount | | | | | |
| the mass content S (mass %) of the at least one compound | — | 10 | 5 | 10 | 15 |
| selected from the group consisting of thegeneral | | | | | |
| formulae (1) and (2) | | | | | |
| total solid concentration C (mass %) of the resin particles | 10 | 13 | 10 | 7 | 10 |
| mass ratio (B/A) | 0.05 | — | — | — | — |
| mass ratio (S/C) | — | 0.8 | 0.5 | 1.4 | 1.5 |

Details of resin particles and organic solvents in Tables 1-4 are as below.

Vinyl chloride-ethylene copolymer: manufactured by Sumika Chemtex Company, Limited, product name: Smieliete 1210, solid content: 50±1 mass %

Vinyl chloride-acryl copolymer: manufactured by Nissin Chemical Industry Co., Ltd. product name: Vinyblan 711, solid content: 50 mass %

Polyester emualsion: manufactured by TAKAMATSU OIL&FAT CO., LTD., product name: PESRESIN A-124GP, solid content: 30 mass %

3-butoxy-N,N-dimethylpropionamide: manufactured by Idemitsu Kosan Co., Ltd., product name: Equamide B-100, solid content: 30 mass %

3-methyl-3-oxetanemethanol: manufactured by Tokyo Chemical Industry Co., Ltd., product name: 3-methyl-3-oxetanemethanol

3-ethyl-3-oxetanemethanol: manufactured by Tokyo Chemical Industry Co., Ltd., product name: 3-ethyl-3-oxetanemethanol

Obtained inks 1-18 of Example 1-18 and inks 20-24 of comparative example 1-5 were filled in ink jetting printer (Product name: IPSiO GXe5500, manufactured by Ricoh Company, LTD.), then solid images were printed on three kinds of substrate, a polyvinyl chloride film (hereinafter called “PVC film”), a polyethylene terephthalate film (hereinafter called “PET film”), and a polyethylene film (hereinafter called “PE film”)).

Printed medium recorded on the PVC film, Printed medium recorded on the PET film were dried at 80° C. for 1 hour. Printed medium recorded on the PE film were dried at 50° C. for 1 hour. Adhesiveness, rub fastness, solvent resistance, non-transfer property, image hardness, and high glossiness of the printed images were evaluated as below. Results are shown in Table 5.

Obtained ink 19 of example 19 were applied on three kinds of substrates heated to 50° C. on a hotplate with the bar coater (Manufactured by Matsuo Sangyo Co., Ltd., #5), a PVC film, a PET film, and a PE film, and then dried for 5 minutes. After this, a black solid image is printed on a white solid image with ink jetting printer (Modified machine of IPSiO GXe5500, manufactured by Ricoh Company, LTD.) filled with ink 2 of the example 2. Further, the printed medium recorded on each of the PVC film and the PET film was dried at 80° C. for 1 hour. The printed medium recorded on the PE film was dried at 50° C. for 1 hour. Adhesiveness, rub fastness, solvent resistance, non-transfer property, image hardness, and high glossiness of the printed images were evaluated as below. Results are shown in Table 5. The modified machine of GXe5500 is modified GXe5500 so as to heat a substrate during recording.

In example 20, the ink 2 of the example 2 was used, and printed mediums were dried by leaving overnight at 25° C. Adhesiveness, rub fastness, solvent resistance, non-transfer property, image hardness, and high glossiness of the printed images were evaluated as below. Results are shown in Table 5.

It is to be noted that image toughness such as adhesiveness to a substrate, rub fastness, and solvent resistance were evaluated by extremely strict evaluation standards in terms of outdoor utilization.

Adhesiveness

Solid part of each images created on three kinds of substrates, a PVC film, a PET film, and a PE film, was examined with the cross-cut adhesion test using fabric adhesive tape where the remaining number of squares out of the 100 squares was counted to evaluate adhesiveness for the substrates in accordance with the following evaluation criteria.

The evaluation criteria is as below. Evaluation B or higher is preferable in terms of actual use. Results of evaluation with respect to the three kinds of substrate, the PVC film, the PET film, and the PE film, were the same.

—Evaluation Criteria—

AA: The number of remaining square was 98 or more.
A: The number of remaining square was 90 or more and less than 98.
B: The number of remaining square was 70 or more and less than 90.
C: The number of remaining square was less than 70.

Rub Fastness

A solid part of image created on three kinds of substrates, a PVC film, a PET film, and a PE film, was rubbed adding 400 g of weight with a cotton (Kanakin #3), and condition of the image was visually observed. Then, rub fastness was evaluated in accordance with the following evaluation criteria.

Evaluation B or higher is preferable in terms of actual use. Results of evaluation with respect to the three kinds of substrate, the PVC film, the PET film, and the PE film, were the same.

—Evaluation Criteria—

AA: The image was not changed even though it was rubbed over 50 times.
A: Scratch remained after being rubbed 50 times, but image density was not affected.
B: Image density was decreased while it was rubbed 30 to 50 times.
C: Image density was decreased by being rubbed 30 or less times.

Solvent Resistance

A solid part of image created on three kinds of substrates, a PVC film, a PET film, and a PE film, was dipped into 60% ethanol solution for 24 hours at normal temperature, was dried for 24 hours at room temperature, and then the density value of the image was examined. The decrement ratio of the density value obtained after the dipping with respect to the initial density value obtained before the dipping was estimated, then solvent resistance was evaluated in accordance with the following criteria.

Evaluation B or higher is preferable in terms of actual use. Results of evaluation with respect to the three kinds of substrate, the PVC film, the PET film, and the PE film, were the same.

—Evaluation Criteria—

AA: The decrement ratio of the density value was 10% or less.
A: The decrement ratio of the density value was 10% or more but not more than 20%.
B: The decrement ratio of the density value was 20% or more but not more than 30%.
C: The decrement ratio of the density value was 30% or more.

Non-Transfer Property

Each of two solid images created on three kinds of substrates, a PVC film, a PET film, and a PE film, with the ink jetting printer (Modified machine of IPSiO GXe5500, manufactured by Ricoh Company, LTD.) was cut into a shape having the size of 2 cm×3 cm. The two of cutout solid images were overlapped so as to be in contact with each other, and then were pressed with a press machine at 1.0 MPa for 10 seconds. After this, the two test samples were separated where observation of separation easiness and observation of defects of images after separation were conducted. By this, non-transfer property was evaluated in accordance with the following evaluation criteria.

Evaluation B or higher is preferable in terms of actual use. Results of evaluation with respect to the three kinds of substrate, the PVC film, the PET film, and the PE film, were the same. The modified machine of GXe5500 is modified GXe5500 so as to heat a substrate during recording.

—Evaluation Criteria—

A: Two solid images were separated naturally without sticking sense and color migration to each substrates was not observed.
B: Two solid images were separated with slight sticking sense and a defects of image were not observed.
C: Two solid images were separated with sticking sense and a defects of image were slightly observed.
D: Two solid images were separated with strong sticking sense and a defects of image were remarkably observed.

Image Hardness

Image Hardness was examined according to JIS K5600-5-4 and evaluated in accordance with the following evaluation criteria. Evaluation B or higher is preferable in terms of actual use. Results of evaluation with respect to the three kinds of substrate, the PVC film, the PET film, and the PE film, were the same.

A: Results of the image hardness was H or higher.
B: Results of the image hardness was B or higher.
C: Results of the image hardness was less than B.

High Glossiness

60° C. glossiness of a solid part of image created on three kinds of substrates, a PVC film, a PET film, and a PE film, was examined four times with a gloss meter (Product name: 4501, manufactured by BYK-Gardner GmbH), the average value was calculated, and then high glossiness was evaluated in accordance with the following criteria.

Evaluation B or higher is preferable in terms of actual use. Results of evaluation with respect to the three kinds of substrate, the PVC film, the PET film, and the PE film, were the same.

—Evaluation Criteria—

AA: The glossiness value was 100 or more.
A: The glossiness value was 90 or more but not more than 100.
B: The glossiness value was 80 or more but not more than 90.
C: The glossiness value was less than 80.

TABLE 5

| | | | | Test results | | | | | | | |
|---|---|---|---|---|---|---|---|---|---|---|---|
| | | | | Adhesion | | | | | Non- | | |
| | | Ink | heated | PVC | PET | PE | Rub | Solvent | Transfer | Image | High |
| | | No. | drying | film | film | film | Fastness | Resistance | Property | Hardness | Glossiness |
| Examples | 1 | 1 | ◯ | AA | AA | AA | A | A | A | B | A A |
| | 2 | 2 | ◯ | AA | AA | AA | A A | A A | A | A | A A |
| | 3 | 3 | ◯ | A A | A A | A | B | A | A | B | C |
| | 4 | 4 | ◯ | A | A | A | A | A | A | C | A |
| | 5 | 5 | ◯ | AA | A | A | A | A | A | A | C |
| | 6 | 6 | ◯ | A A | A A | AA | A A | A A | B | B | A A |
| | 7 | 7 | ◯ | A A | A A | B | A A | A A | A | A | B |
| | 8 | 8 | ◯ | A A | A A | B | A | A | A | A | A |
| | 9 | 9 | ◯ | A | A | B | A A | B | A | B | A |
| | 10 | 10 | ◯ | A | A | B | A | A | A | B | A A |
| | 11 | 11 | ◯ | A | A A | B | A | B | C | B | A A |
| | 12 | 12 | ◯ | A | A A | B | A | B | A | B | A |
| | 13 | 13 | ◯ | B | A | B | A | B | A | A | B |
| | 14 | 14 | ◯ | A | A | B | A | A | A | A | A |
| | 15 | 15 | ◯ | A | A A | B | A A | A | B | A | A A |
| | 16 | 16 | ◯ | A | A | B | A | A | A | B | A |
| | 17 | 17 | ◯ | A | A | B | A A | A A | A | A | A A |
| | 18 | 18 | ◯ | B | B | B | A | A | A | B | A |
| | 19 | 192 | ◯ | AA | AA | AA | A A | A A | A | A | A A |
| | 20 | 2 | X | A | A | AA | A | A | B | B | A A |
| Comparative | 1 | 20 | ◯ | B | B | B | C | B | B | B | C |
| Examples | 2 | 21 | ◯ | AA | B | AA | C | A | A | C | B |
| | 3 | 22 | ◯ | B | A A | C | A | B | A | B | A |
| | 4 | 23 | ◯ | A | A A | C | C | B | A | A | A |
| | 5 | 24 | ◯ | B | A | C | C | C | A | C | B |

The examples 1 and 2 are the preferable examples of the present disclosure. It can be understood that examples 1 and 2 shows extremely high adhesiveness and that toughness (rub fastness, solvent resistance, and non-transfer property) and high glossiness are obtained by examples 1 and 2. Example 3 is an example where the compound of the general formula (1) is included in slightly smaller amount. Mixing property of two kinds of resin particles used in this example is slightly less good, with the result that toughness and high glossiness are less good than the example 2. Example 4 is an example where the difference in content between two kinds of included resin particles is slightly large, and shows slightly weaker synergistic effect from the combined use of the two kinds of resins than the example 2. Example 5 is an example where the difference in content between two kinds of included resin particles is slightly small, and shows slightly weaker synergistic effect from the combined use of the two kinds of resins than example 2.

Examples 6 to 8 are examples where the most preferable compound, 3-methoxy-N,N-dimethylpropanamide, among the compounds represented by the general formula (1) or (2) is not chosen, and show slightly lower image quality (image hardness and high glossiness) and slightly lower adhesiveness with respect to the substrate than the example 2.

Examples 9-12 are examples where the polyurethane resin particle is used as a resin particle included in the highest amount, and where the polyester resin particle is used as the other resin particle than the resin particle included in the highest amount. The examples 9-12 show slightly lower image quality and slightly lower adhesiveness with respect to the substrate than the combination of polyurethane resin particle and polyvinyl chloride in example 2.

Examples 13-15 are examples where the polyurethane resin particle is used as a resin particle included in the highest amount, and where the acrylic resin particle is used as the other resin particle than the resin particle included in the highest amount. Examples 13-15 show slightly lower image quality and slightly lower adhesiveness with respect to the substrate than the combination of polyurethane resin particle and polyvinyl chloride in example 2.

Examples 16-18 are examples where the polyurethane resin particle is not used and show slightly lower image quality and slightly lower image toughness than the combination of polyurethane resin particle and polyvinyl chloride in example 2. Example 19 is an example where image is recorded on the white ink and shows high toughness and high image quality as the example 2. Example 20 is an example where heating process after recording is not provided, and shows lower non-transfer property and lower image hardness than example 2 but not lower than the level of out-of-order.

Comparative example 1 is an example where a compound represented by the general formula (1) or (2), and shows lower adhesiveness, lower toughness, and lower image quality than example 1. Comparative examples 2 to 5 are examples where only one kind of resin particle is used, show lower adhesiveness, lower toughness, and lower image quality than example 1.

It is understood from the above results that the ink of the present disclosure is suitable for outdoor use. The inks of the examples 1-19 compare favorably with solvent ink-jetting inks in adhesiveness, rub fastness, solvent resistance, image hardness, and high glossiness.

Preferred embodiments described and enabled herein include the following:

1. An ink comprising:

water;

an organic solvent;

at least two kinds of resin particles; and

at least one compound selected from formulae (1) and (2):

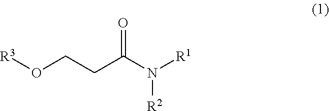

where R¹, R², and R³, which may be the same or different, each independently represents an alkyl group having 1 to 5 carbon atoms,

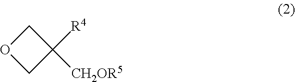

where R⁴ represents a methyl group or an ethyl group, and R⁵ represents a hydrogen atom, an alkyl group having 1 to 8 carbon atoms, a cycloalkyl group or an aryl group.
2. The ink according to embodiment 1, wherein the mass ratio (B/A) is 0.05 to 0.3 where A is the mass % of the resin particles present in the ink in the largest amount based on the total mass of all particles in the ink and B is the mass % of the all the resin particles present in the ink except the resin particles present in the ink in the largest amount.
3. The ink according to embodiment 1, wherein the mass ratio (S/C) of the mass content S (mass %) of the at least one compound selected from formulae (1) and (2) based on the total mass of the ink and the total solid concentration C (mass %) of the resin particles present in the ink based on the total mass of the ink is from 0.3 to 1.5.
4. The ink according to embodiment 1, wherein the at least one compound selected from formulae (1) and (2) comprises 3-methoxy-N,N-dimethylpropionamide.
5. The ink according to embodiment 1, wherein one of the at least two kinds of resin particles is polyurethane resin particles.
6. The ink according to embodiment 1, wherein two of the at least two kinds of resin particles are polyurethane resin particles and polyvinylchloride resin particles.
7. The ink according to embodiment 1, wherein the organic solvent is selected from 1,2-propane diol, 1,2-butane diol, 2,3-butane diol, 2-methyl-2,4-pentane diol, and dipropylene glycol monomethyl ether.
8. An ink-jetting recording method, comprising recording an image by stimulating and discharging the ink of embodiment 1.
9. The ink-jetting recording method according to embodiment 8, further comprising heating the image after the recording.
10. A record, comprising an image formed of the ink of embodiment 1.

As used herein the terms composed of, contains, containing, and terms similar thereto, when referring to the ingredients, parts, reactants, etc., of a composition, component, etc., to method steps, etc., mean, in their broadest sense, “includes at least” (i.e., comprises) but also include within their definition all those gradually restricted meanings until and including the point where only the enumerated materials or steps are included (e.g., consisting essentially of and consisting of).

The above written description of the invention provides a manner and process of making and using it such that any person skilled in this art is enabled to make and use the same, this enablement being provided in particular for the subject matter of the appended claims, which make up a part of the original description. As used herein, the phrases “selected from the group consisting of,” “chosen from,” and the like include mixtures of the specified materials. The term “mentioned” notes exemplary embodiments, and is not limiting to certain species. As used herein the words “a” and “an” and the like carry the meaning of “one or more.” When a polymer is referred to in shorthand notation as comprising a monomer (or like phrases), the monomer is present in the polymer in polymerized form.

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out.

What is claimed is:

1. An ink comprising:
water;
an organic solvent;
at least two kinds of resin particles; and
at least one compound selected from formulae (1) and (2): 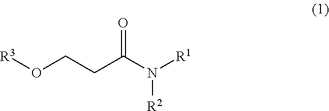
where R¹, R², and R³, which may be the same or different, each independently represents an alkyl group having 1 to 5 carbon atoms, 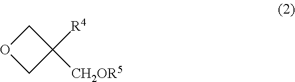
where R⁴ represents a methyl group or an ethyl group, and R⁵ represents a hydrogen atom, an alkyl group having 1 to 8 carbon atoms, a cycloalkyl group or an aryl group.

2. The ink according to claim 1, wherein the mass ratio (B/A) is 0.05 to 0.3 where A is the mass % of the resin particles present in the ink in the largest amount based on the total mass of all particles in the ink and B is the mass % of the all the resin particles present in the ink except the resin particles present in the ink in the largest amount.

3. The ink according to claim 1, wherein the mass ratio (S/C) of the mass content S (mass %) of the at least one compound selected from formulae (1) and (2) based on the total mass of the ink and the total solid concentration C (mass %) of the resin particles present in the ink based on the total mass of the ink is from 0.3 to 1.5.

4. The ink according to claim 1, wherein the at least one compound selected from formulae (1) and (2) comprises 3-methoxy-N,N-methylpropionamide.

5. The ink according to claim 1, wherein at least one of the at least two kinds of resin particles are polyurethane resin particles.

6. The ink according to claim 1, wherein two of the at least two kinds of resin particles are polyurethane resin particles and polyvinylchloride resin particles.

7. The ink according to claim 1, wherein the organic solvent is selected from 1,2-propane diol, 1,2-butane diol, 2,3-butane diol, 2-methyl-2,4-pentane diol, and dipropylene glycol monomethyl ether.

8. The ink according to claim 1, comprising at least one compound of formula (1).

9. The ink according to claim 1, comprising at least one compound of formula (2).

10. An ink-jetting recording method, comprising recording an image by stimulating and discharging the ink of claim 1.

11. The ink-jetting recording method according to claim 8, further comprising heating the image after the recording.

12. A record, comprising an image formed of the ink of claim 1.
